(19) United States
(12) Patent Application Publication
(10) Pub. No.: US 2003/0009522 A1
(43) Pub. Date: Jan. 9, 2003

(54) Method for propagating teamware transactions

(76) Inventors: Sadhana S. Rau, Palo Alto, CA (US); Anatoli Fomenko, San Jose, CA (US); Mark W. Dey, Oakland, CA (US); Nikolay Molchanov, Fremont, CA (US); Anatoly Zvezdin, Novosibirsk (RU)

Correspondence Address: ROSENTHAL & OSHA L.L.P., 1221 MCKINNEY AVENUE, SUITE 2800, HOUSTON, TX, 77010, US

(21) Appl. No.: 09/899,555

(22) Filed: Jul. 5, 2001

(51) Int. Cl. G06F 15/16

(52) U.S. Cl. 709/205

(57) ABSTRACT

A method for propagating changes from a local workspace that is accessible by a client to a remote workspace that is accessible by a server includes generating a request from the client to the server to create a temporary workspace, obtaining selected data from the local workspace and requesting the server to store the selected data in the temporary workspace, and updating the remote workspace with the data in the temporary workspace. To propagate changes from the remote workspace to the local workspace, the method includes creating a temporary workspace that is accessible by the client, requesting the server to send selected data from the remote workspace, storing the selected data in the temporary workspace, and updating the local workspace with the selected data in the temporary workspace.

### CROSS-REFERENCE TO RELATED APPLICATIONS

U.S. patent application Ser. No. ______, entitled “Teamware Server Working over HTTP/HTTPS connections” and U.S. patent application Ser. No. ______, entitled “Teamware Repository of Teamware Workspaces,” both filed contemporaneously herewith, contain subject matter related to the disclosure herein.

### BACKGROUND OF INVENTION

1. Field of the Invention

The invention relates generally to “teamware,” a category of software that enables a team of people, especially people distributed over multiple locations, to collaborate on projects. More specifically, the invention relates to methods and systems for managing teamware workspaces.

2. Background Art

One of the major challenges in developing large-scale (multi-platform) software is coordinating the activities of a team of people, i.e., developers, testers, technical writers, and managers. To improve productivity, time-to-market, and quality of the software, the various phases of the development life cycle typically evolve concurrently, i.e., in parallel. Concurrent software development requires that the developers have access to common software base for the purpose of developing and building the software. The main challenge with this type of development process is how to control access to the software base and track the changes made to the software base so that the integrity of the software base is maintained. It should be noted that at any point in time, various configurations of the software base might exist because the various phases of the development cycle are evolving concurrently.

Most development teams use a Software Configuration Management (SCM) system to manage the software base. SCM systems, such as Concurrent Versions System (CVS), track the changes made to the files under their control and facilitate merging of code. Sophisticated SCM systems, such as Rational® ClearCase® from Rational Software Corporation and Forte™ TeamWare from Sun Microsystems, Inc., provide other capabilities such as software building and process management (e.g., what changes can be made to the software base and who can make the changes).

SCM systems, such as Forte™ TeamWare, allow creation of one or more isolated workspaces. The term “workspace” refers to a directory, its subdirectories, and the files contained in those directories. Typically, the files are maintained under a version control system, such as Source Code Control System (SCCS) or Revision Control System (RCS). To use Forte™ TeamWare for software management, the developers initially place their project directories and files (if available) in one high-level directory. Forte™ TeamWare then transforms the high-level directory into a top-level (or parent) workspace. If project directories and files are not available, an empty parent workspace is created. After creating the parent workspace, the developers create their own child workspaces with copies of the parent workspace files. The developers can then modify individual versions of the same file in their child workspaces without interfering with the work of other developers. After the files are modified in the child workspaces, they are merged and copied to the parent workspace. Merging of files generally involves resolving conflicts between individual versions of the same file.

Transactions between a child workspace and a parent workspace generally revolve around three relationships: bring-over files from the parent workspace, modify files in the child workspace, and put-back files to the parent workspace. Forte™ TeamWare (version 6) as currently implemented only supports transactions between two local workspaces. Two workspaces are “local” if local access methods or network file sharing protocols, such as NFS (“Network File System”) on UNIX® or SMB (“Server Message Block”) on Windows®, can be used to transfer files between the workspaces. NFS, for example, operates as a client-server application. A computer that shares its resources with other computers on the network using the NFS service is known as an NFS server. The computers sharing the resources of the NFS server are known as NFS clients. Using NFS service, a resource physically linked to a NFS server may be NFS mounted. Once the resource is NFS mounted, it becomes accessible to all NFS clients as if it were stored locally at each client. Similarly, SMB server provides file sharing services to SMB clients.

Typically, the parent workspace is located on a different machine than the one on which the child workspace is located. In this arrangement, the computer on which the parent workspace resides can be referred to as a server, and the computer on which the child workspace resides can be referred to as a client. Thus, if the server is a UNIX® system and the client is a Windows® system, either the server would have to install an implementation of SMB or the client would have to install an implementation of NFS to execute transactions between the workspaces. In other words, both the server and client are required to have an implementation of the same network file sharing protocol to execute transactions between the workspaces. This may not always be possible or convenient because there are several operating systems on the market and an implementation of a particular network file sharing protocol may not be available for all operating systems. In this situation, a mechanism that allows transactions to be executed between a local workspace (on the client side) and a remote workspace (on the server side) is desired.

### SUMMARY OF INVENTION

In one aspect, the invention relates to a method for propagating changes from a local workspace that is accessible by a client to a remote workspace that is accessible by a server. The method comprises generating a request from the client to the server to create a temporary workspace, obtaining selected data from the local workspace and requesting the server to store the selected data in the temporary workspace, and updating the remote workspace with the data in the temporary workspace.

In another aspect, the invention relates to a method for propagating changes from a remote workspace that is accessible by a server to a local workspace that is accessible by a client. The method comprises creating a temporary workspace that is accessible by the client, requesting the server to send selected data from the remote workspace, storing the selected data in the temporary workspace, and updating the local workspace with the selected data in the temporary workspace.

Other features and advantages of the invention will be apparent from the following description and the appended claims.

### BRIEF DESCRIPTION OF DRAWINGS

FIG. 1 shows a block diagram of a teamware system that remote transactions to be executed between a local workspace and a remote workspace.

FIG. 2 shows the teamware system at runtime.

FIG. 3 shows a mechanism for invoking a server method remotely.

FIG. 4A is a flowchart illustrating transaction logic for a putback to remote workspace transaction.

FIG. 4B is a continuation of the flowchart shown in FIG. 4A.

FIG. 5A is a flowchart illustrating transaction logic for a bringover from remote workspace transaction.

FIG. 5B is a continuation of the flowchart shown in FIG. 5A.

### DETAILED DESCRIPTION

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

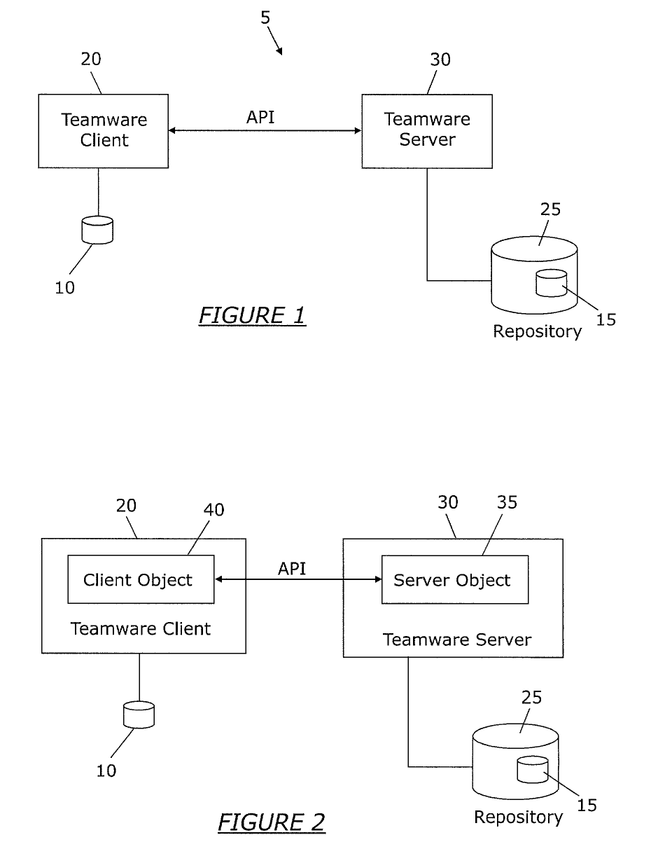

Referring now to the accompanying drawings, FIG. 1 shows a block diagram of a teamware system 5 that allows transactions to be executed between a local workspace 10 and a remote workspace 15. The local workspace 10 is local in the sense that a teamware client 20 uses local access methods or a network file sharing protocol to access the contents of the local workspace 10. The remote workspace 15 is remote in the sense that the teamware client 20 does not use local methods or a network file sharing protocol to access the contents of the remote workspace 15. In the figure, the remote workspace 15 is shown inside a repository 25, such as described in U.S. patent application Ser. No. ______, entitled “Teamware Repository of Teamware Workspaces,” herein incorporated by reference. In accordance with this embodiment, the teamware system 5 includes a teamware server 30 that manages and provides access to the repository 25 and remote workspace 15. The teamware client 20 communicates with the teamware server 30 via an application programmer interface (API). The teamware client 20 executes the transaction logic locally and sends certain commands to the teamware server 30 to be executed at the teamware server 30. The result, such as the content of a file, an object, or an exception, is returned to the teamware client 20.

The teamware client 20 and teamware server 30 may be software components written in Java™ or another programming language. At runtime, as shown in FIG. 2, the teamware server 30 includes one or more server objects 35 (only one is shown) that implement the API. To execute a command at the teamware server 30, a client object 40 invokes a server method (defined in the API) by sending a message to the server object 35. The server object 35 executes the corresponding operation and returns the result to the client object 40. If the teamware client 20 and teamware server 30 run in different virtual machines, the server object 35 is considered to be remote to the client object 40. If the virtual machines are located on the same computer or on separate computers connected via a network file sharing protocol, a mechanism such as Remote Method Invocation (RMI) can be used to remotely invoke the methods of the server object 35. If the virtual machines are on separate computers that are not connected by a network file sharing system, a mechanism such as described in U.S. patent application Ser. No. ______, entitled “Teamware Server Working Over HTTP/HTTPS Connections,” herein incorporated by reference, can be used to invoke the methods of the server object 35.

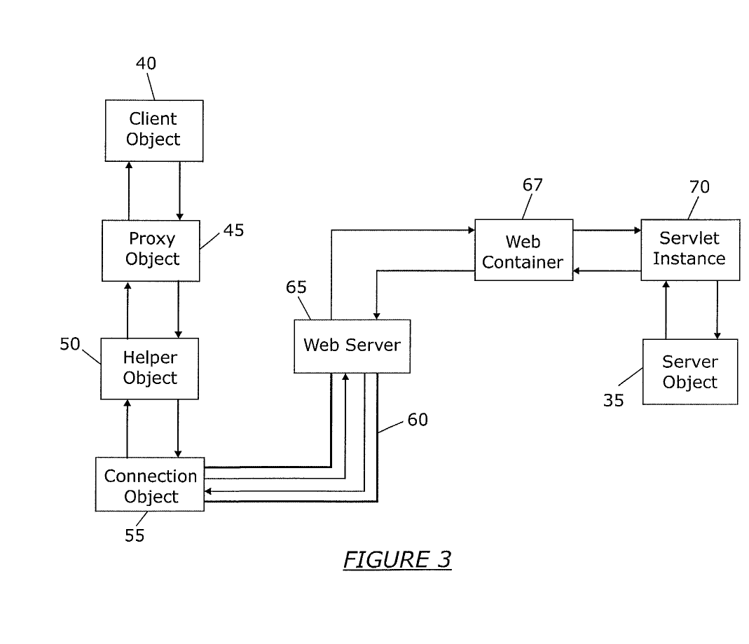

FIG. 3 shows how the mechanism described in U.S. patent application Ser. No. ______, entitled “Teamware Server Working Over HTTP/HTTPS Connections,” works. To invoke a method of the server object 35, the client object 40 makes a method call to a proxy object 45 which has the same interface as the server object 35. The proxy object 45 forwards the method call to a helper object 50. The helper object 50 analyzes the method call, marshals the parameters included in the method call, and converts the method call to a HTTP request. The helper object 50 passes the HTTP request to a connection object 55, which sets up a connection 60 with a web server 65 and sends the HTTP request to the web server 65 over the connection 60. The connection 60 is based on HTTP or HTTPS protocol. The web server 65 passes the HTTP request to a web container 67. A servlet 70 and the server object 35 are instantiated inside the web container 70. The servlet 70 parses the request and delegates processing of the request to the server object 35. The server object 35 processes the request and returns the results to the servlet 35. The results are passed to the servlet 35, web container 67, and then the web server 65. The web server 65 sends a HTTP response (including the results) to the client object 40.

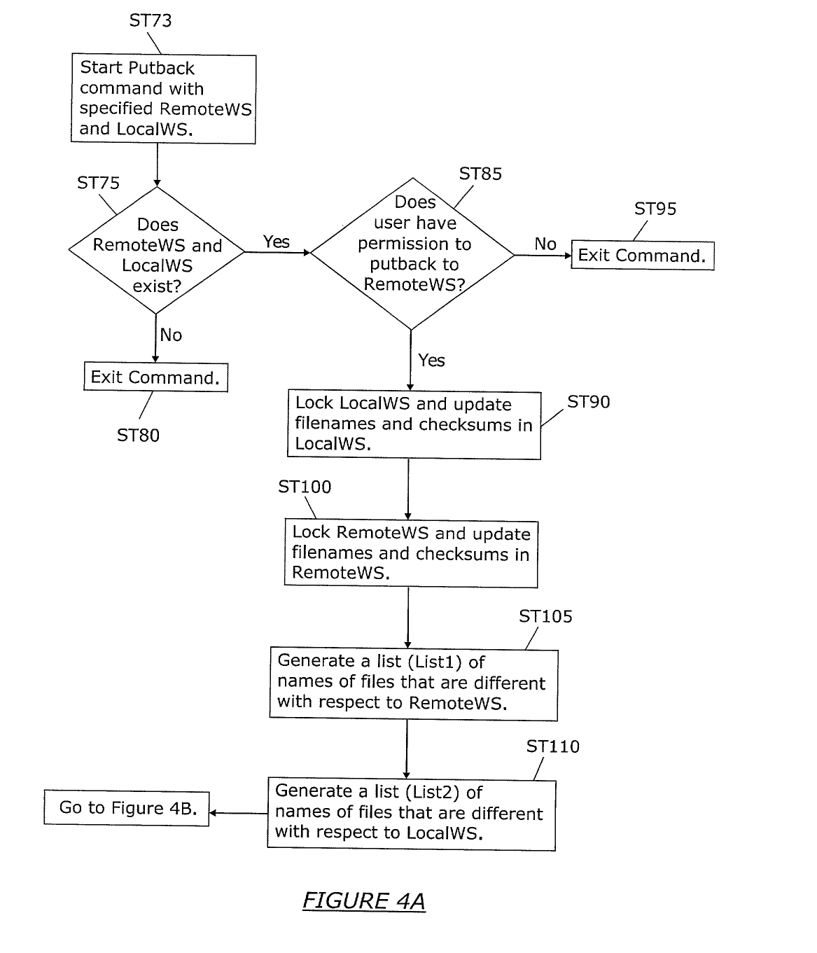

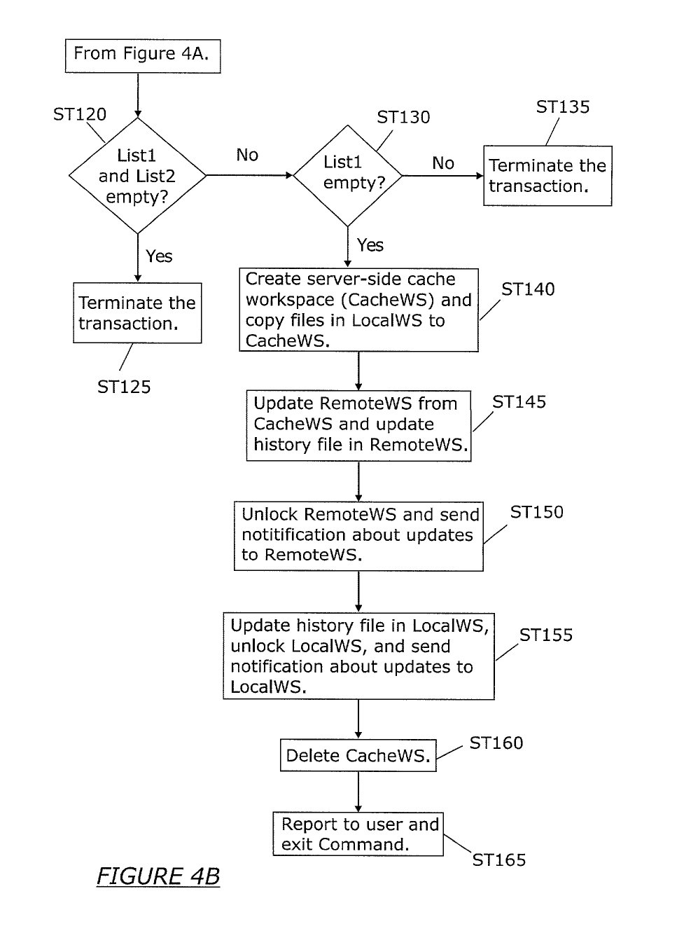

Returning to FIG. 1, various types of transactions can be executed between the local workspace 10 and the remote workspace 15. One type of transaction that can be executed is putback to remote workspace. This transaction enables teamware client 20 to propagate changes from its local workspace (LocalWS), e.g., local workspace 10, to a remote workspace (RemoteWS), e.g., remote workspace 15, through the teamware server 30. Referring to FIG. 4A, the user starts the transaction, as indicated at ST73, by instructing the teamware client (20 in FIG. 1) to execute a command statement such as:

putback -w http://servername.domainname:portnumber/RemoteWS

LocalWS 8 list of files and directories].

The command statement includes the names and locations of the workspaces involved in the transaction and an optional list of user-specified files and directories. The location of RemoteWS is expressed as a URL, where “http://” is the Web protocol, “servername” is the name of the web server on which RemoteWS (directory) is installed, and “domainname” is the domain name (e.g., .com, org, .edu, .net, etc), and “portnumber” is the port assigned to the teamware server 30. Domain name and port number are optional. When domain name and port number are dropped, default values will be used for them. This command statement can be used when the teamware client (20 in FIG. 1) and teamware server (30 in FIG. 1) communicate using the mechanism described in FIG. 3.

The putback transaction can be divided into four phases, including initialization, handshaking, transfer, and update. The initialization phase of the transaction involves checking for the existence of LocalWS and RemoteWS (ST75). The teamware client (20 in FIG. 1) can use normal file operations to check for existence of LocalWS. To check for existence of RemoteWS, the teamware client (20 in FIG. 1) sends an appropriate message to the teamware server (30 in FIG. 1) using, for example, the mechanism described in FIG. 3. The teamware server (30 in FIG. 1) sends a response to the teamware client (20 in FIG. 1) which indicates whether RemoteWS exists or not. If LocalWS and RemoteWS do not exist, the teamware client (20 in FIG. 1) exits the command (ST80). If LocalWS and RemoteWS exist, the initialization phase further includes checking if the user has permission to putback to RemoteWS (ST85). Again, this involves the teamware client (20 in FIG. 1) sending an appropriate message to the teamware server (30 in FIG. 1) and receiving a corresponding response. If the user has permission to putback to RemoteWS, the teamware client (20 in FIG. 1) locks LocalWS and updates the filenames and checksums in LocalWS (ST90). The checksums are computer values that depend on the contents of the workspace files. If the user does not have permission to putback to RemoteWS, the teamware client (20 in FIG. 1) exits the command (ST95).

The handshaking phase of the transaction occurs if the user has permission to putback to RemoteWS. The handshaking phase involves the teamware client (20 in FIG. 1) asking the teamware server (30 in FIG. 1) to lock RemoteWS and update filenames and checksums in RemoteWS (ST100). RemoteWS is locked so that other users do not make updates to RemoteWS during this phase. The handshaking phase further includes generating a list of names of files that are different with respect to RemoteWS (ST105). This list is called List1. List1 contains the files to be transferred from RemoteWS to LocalWS. The handshaking phase further includes generating a list of names of files that are different with respect to LocalWS (ST115). This list is called List 2. List2 contains the files to be transferred from LocalWS to RemoteWS.

To generate the lists, teamware client (20 in FIG. 1) asks the server (30 in FIG. 1) for the filenames and checksums in RemoteWS. Then, List1 is generated as follows: for each filename from RemoteWS, check if the filename exists in LocalWS. If the filename exists, check if the checksum for both files (in RemoteWS and LocalWS) are the same. If the checksums are not the same or the filename does not exist in LocalWS, add the filename to List1. List2 is generated as follows: for each filename from LocalWS, check if the filename exists in RemoteWS. If the filename exists, check if the checksum for both files (in RemoteWS and LocalWS) are the same. If the checksums are not the same or the filename does not exist in RemoteWS, add the filename to List2.

Referring to FIG. 4B, the handshaking phase further includes checking if both List1 and List2 are empty (ST120). If both List1 and List2 are empty, then there are no changes to be propagated, and the transaction is terminated (ST125). To terminate the transaction, the teamware client (20 in FIG. 1) asks the server (30 in FIG. 1) to unlock RemoteWS. The teamware client (20 in FIG. 1) then unlocks LocalWS, reports to the user, and exits the command. At ST130, the teamware client (20 in FIG. 1) determines if List1 is empty. If List1 is not empty, then there are changes to be propagated from RemoteWS to LocalWS. In this case, the putback operation is terminated (ST135), as described above, allowing the user to initiate the operation needed to propagate changes from RemoteWS to LocalWS.

The transfer phase involves the teamware client (20 in FIG. 1) sending a message to the teamware server (30 in FIG. 1) to allocate cache workspace (CacheWS) and copy files from LocalWS to CacheWS according to List2 (ST140). Putting files in CacheWS involves teamware client (20 in FIG. 1) sending messages to the teamware server (30 in FIG. 1) with the data in LocalWS, and the teamware server (30 in FIG. 1) storing the received data in CacheWS.

The update phase involves the teamware client (20 in FIG. 1) asking the teamware server (30 in FIG. 1) to update RemoteWS from CacheWS (ST145). The history in RemoteWS, i.e., a history file containing list of transactions that have occurred in RemoteWS, is also updated. After the teamware client (20 in FIG. 1) receives notification of the update, the teamware client (20 in FIG. 1) asks the teamware server (30 in FIG. 1) to unlock RemoteWS and send notifications about putback to RemoteWS to the teamware system (ST150). This is so that other teamware clients can update their workspaces. Next, the teamware client (20 in FIG. 1) updates history in LocalWS, unlocks LocalWS, and sends notifications about putback to RemoteWS from LocalWS (ST155). The teamware client (20 in FIG. 1) asks the teamware server (30 in FIG. 1) to delete CacheWS. The teamware client (20 in FIG. 1) then reports to the user and exits the command (ST165).

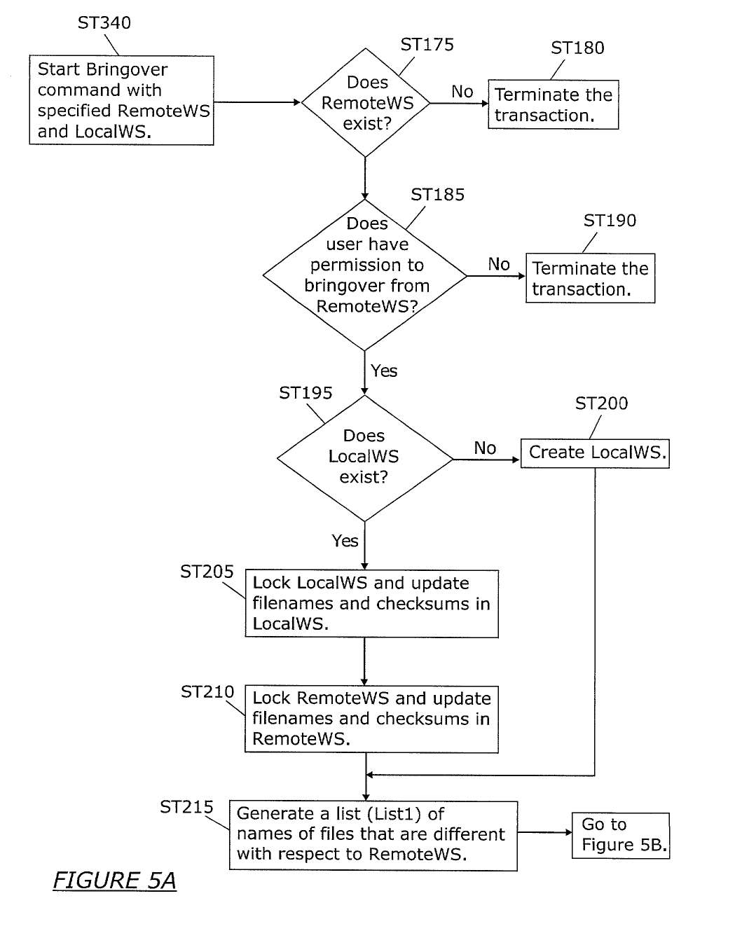

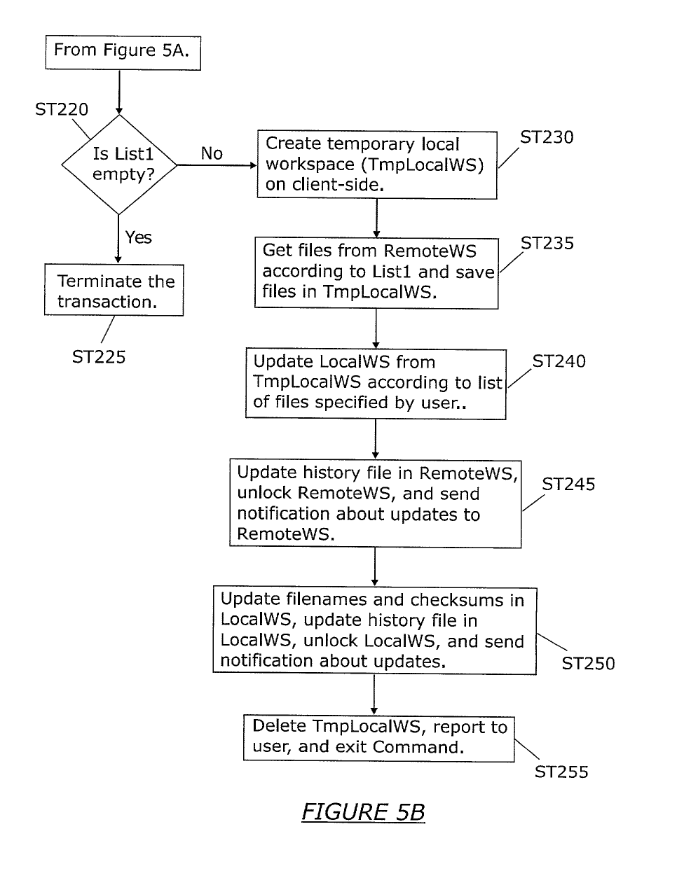

Returning to FIG. 1, another type of transaction that can be executed is bringover from remote workspace. This transaction enables teamware client 20 to propagate changes from its remote workspace (RemoteWS), e.g., remote workspace 15, to a local workspace (LocalWS), e.g., local workspace 10, through the teamware server 30. Referring to FIG. 5A, the user starts the transaction, as indicated at ST170, by instructing the teamware client (20 in FIG. 1) to execute a command statement such as:

bringover -w

http://servername.domainname:portnumber/RemoteWS -p LocalWS 8 list of files and directories].

As in the previous transaction, the command executes in four phases, including initialization, handshaking, transfer, and update. In the initialization phase, the teamware client (20 in FIG. 1) logs into the teamware server (30 in FIG. 1) if not already logged in and connects to RemoteWS. Next, the teamware client (20 in FIG. 1) asks the teamware server (30 in FIG. 1) if RemoteWS exists (ST175). If RemoteWS does not exist, the transaction is terminated (ST180). If RemoteWS exists, the initialization phase further includes checking if the user has permission to bringover from RemoteWS (ST185). If the user does not have permission, the transaction is terminated (ST190). If the user has permission, the teamware client (20 in FIG. 1) checks for existence of LocalWS (ST195). If LocalWS does not exist, the teamware client (20 in FIG. 1) creates LocalWS and updates the parent file of LocalWS to include RemoteWS (ST200). If LocalWS exists, the teamware client (20 in FIG. 1) locks LocalWS and updates filenames and checksums in LocalWS (ST205).

The handshaking phase involves the teamware client (20 in FIG. 1) asking the teamware server (30 in FIG. 1) to lock RemoteWS and update filenames and checksums in RemoteWS (ST210). The handshaking phase further includes generating a list of names of files that are different with respect to RemoteWS (ST215). This list is called List1. List1 includes the files to be brought over from RemoteWS to LocalWS. To generate the lists, teamware client (20 in FIG. 1) asks the server (30 in FIG. 1) for the filenames and checksums in RemoteWS. List1 is generated as follows: for each filename from RemoteWS, check if the filename exists in LocalWS. If the filename exists, check if the checksum for both files (in RemoteWS and LocalWS) are the same. If the checksums are not the same or the filename does not exist in LocalWS, add the filename to List1.

Referring to FIG. 5B, the handshaking phase further includes checking if List1 is empty. If List1 is empty, there are no changes to be propagated from RemoteWS to LocalWS, and the transaction is terminated (ST225). To terminate the transaction, the teamware client (20 in FIG. 1) asks the teamware server (30 in FIG. 1) to unlock RemoteWS. Then the teamware client (20 in FIG. 1) unlocks LocalWS, reports, and exits the command.

If List1 is not empty, the transfer phase is started. In the transfer phase, the teamware client (20 in FIG. 1) creates a temporary empty local workspace (TmpLocalWS), as indicated at ST230. The transfer phase further includes the teamware client (20 in FIG. 1) sending a message to the teamware server (30 in FIG. 1) to provide files in RemoteWS according to List1 (ST235). The files are saved in TmpLocalWS. TmpLocalWS acts as a temporary storage for files from RemoteWS. Updates are made to LocalWS from TmpLocalWS. The main idea of creating TmpLocalWS is to prevent partial updates to LocalWS. Updates are made to LocalWS when all the necessary RemoteWS files are received in TmpLocalWS. It should be noted that if LocalWS is newly created (such as at ST200 in FIG. 5A) there is no need to create TmpLocalWS. Instead, files can be moved directly from RemoteWS to LocalWS.

33 The update phase involves the teamware client (20 in FIG. 1) updating LocalWS from TmpLocalWS using List1 or a list of files provided by the user (ST240). After updating LocalWS, the teamware client (20 in FIG. 1) asks the server to update history in RemoteWS, unlock RemoteWS, and send notifications about bringover from RemoteWS (ST245). The teamware client (20 in FIG. 1) then updates filenames and checksums in LocalWS, updates history file in LocalWS, unlocks LocalWS, and sends notifications about bringover from RemoteWS to LocalWS (ST250). The teamware client (20 in FIG. 1) deletes TmpLocalWS, reports, and exits (ST255). If there are conflicts during the bringover operation, and the user chooses not to resolve the conflicts, the conflicts will be reported in the bringover notification.

In summary, the invention allows changes to be propagated between a local workspace (client side) and a remote workspace (server side). The mechanism for propagating changes operates independently of operating systems because actual updates are made locally. Thus, for example, to make updates to the remote workspace, the updated files from the local workspace are placed in a cache workspace that is local to the remote workspace. Then, the remote workspace is updated with the changes in the cache workspace. The mechanism tries to minimize the time for which to lock the workspaces. Thus, for example, the workspaces are not locked until it is determined that they physically exist and that the user has permission to execute transactions between the workspaces. Another rule followed in the transaction logic is not to apply partial updates to the workspace. Using this rule, the files to be used in updating a workspace must all be received in a temporary workspace that is local to the workspace to be updated before the workspace is actually updated. The main goal is to maintain the integrity of the workspace and its contents and avoid the situation where the workspace is partially updated because of a lost connection.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for propagating changes from a local workspace that is accessible by a client to
a remote workspace that is accessible by a server, comprising:
generating a request from the client to the server to create a temporary workspace;
obtaining selected data from the local workspace and requesting the server to store the selected data in the temporary workspace; and
updating the remote workspace with the data in the temporary workspace.

2. The method of claim 2, wherein at least one servlet parses requests sent to the server and delegates processing of the requests to an appropriate server object in the server.

3. The method of claim 3, wherein the remote workspace is stored in a repository.

4. The method of claim 4, wherein a server object implements an interface having a set of methods that can be invoked to access the repository and the remote workspace.

5. The method of claim 1, wherein the client communicates with the server using HTTP protocol.

6. The method of claim 1, wherein the client communicates with the server using HTTPS protocol.

7. The method of claim 1, wherein obtaining selected data from the local workspace comprises determining a set of different files between the local and remote workspaces.

8. The method of claim 7, wherein determining the set of different files comprises the client sending a request to the server for filenames and checksums in the remote workspace.

9. The method of claim 8, wherein determining the set of different files further comprises the client comparing the filenames and checksums in the remote workspace with filenames and checksums in the local workspace.

10. The method of claim 9, wherein comparing the filenames and checksums comprises including a filename in the local workspace having a checksum that differs from that of a corresponding filename in the remote workspace in the set of different files.

11. The method of claim 10, wherein comparing the filenames and checksums further comprises including a filename that appears in the local workspace but not in the remote workspace in the set of different files.

12. The method of claim 1, further comprising checking for physical existence of the local workspace and requesting the server to check for physical existence of remote workspace prior to requesting the server to create the temporary workspace.

13. The method of claim 1, further comprising requesting the server to lock the remote workspace prior to updating the remote workspace with the data in the temporary workspace.

14. The method of claim 1, further comprising requesting the server to update history of transactions in the remote workspace after the remote workspace is updated.

15. The method of claim 1, further comprising updating history of transactions in the local workspace after the remote workspace is updated.

16. The method of claim 1, further comprising deleting the temporary workspace after the remote workspace is updated.

17. A method for propagating changes from a remote workspace that is accessible by a server to a local workspace that is accessible by a client, comprising: p1 creating a temporary workspace that is accessible by the client; p1 requesting the server to send selected data from the remote workspace; p1 storing the selected data in the temporary workspace; and p1 updating the local workspace with the selected data in the temporary workspace.

18. The method of claim 17, further comprising the server authenticating the client prior to sending the selected data to the client.

19. The method of claim 17, wherein requesting the server to send selected data comprises determining a set of files that are different between the local and remote workspaces.

20. The method of claim 19, wherein determining the set of files comprises the client sending a request for filenames and checksums in the remote workspace.

21. The method of claim 20, wherein determining the set of different files further comprises the client comparing the filenames and checksums from the remote workspace with the filenames and checksums from the local workspace.

22. The method of claim 21, wherein comparing the filenames and checksums comprises including a filename in the remote workspace having a checksum that differs from that of a corresponding filename in the local workspace in the set of different files.

23. The method of claim 22, wherein comparing the filenames and checksums further comprises including a filename that appears in the remote workspace but not in the local workspace in the set of different files.

24. The method of claim 23, wherein requesting the server to send the selected data comprises requesting the server to send the files including in the set of different files.

25. The method of claim 17, wherein at least one servlet parses requests sent to the server and delegates processing of the requests to an appropriate server object in the server.

26. The method of claim 25, wherein the remote workspace is stored in a repository.

27. The method of claim 26, wherein the appropriate server object implements an interface having a set of methods that can be invoked to access the repository and the remote workspace.

28. The method of claim 17, wherein the client communicates with the server using HTTP protocol.

29. The method of claim 17, wherein the client communicates with the server using HTTPS protocol.

30. The method of claim 17, further comprising allowing a user to resolve conflicts while updating the local workspace with the selected data in the temporary workspace.

31. The method of claim 17, further comprising checking for physical existence of the remote workspace prior to creating the temporary workspace.

32. The method of claim 31, further comprising checking for physical existence of the local workspace and creating the local workspace if the local workspace does not physically exist.

33. The method of claim 17, further comprising deleting the temporary workspace after updating the local workspace.

34. The method of claim 17, further comprising updating history of transactions in the local workspace and requesting the server to update history of transactions in the remote workspace.

35. A computer-readable medium having stored thereon a program for initiating a transaction between a local workspace on a client and a remote workspace on a server, the program being executable by a processor and comprising instructions for:
requesting the server to create a temporary workspace;
obtaining selected data from the local workspace;
requesting the server to store the selected data in the temporary workspace; and
requesting the server to update the remote workspace with the data in the temporary workspace.

36. A computer-readable medium having stored thereon a program for initiating a transaction between a local workspace on a client and a remote workspace on a server, the program being executable by a processor and comprising instructions for:
creating a temporary workspace;
requesting the server to send selected data from the remote workspace to the client;
storing the selected data in the temporary workspace; and
updating the local workspace with the data in the temporary workspace.
